(19) United States
(12) Patent Application Publication
(10) Pub. No.: US 2002/0105578 A1
(43) Pub. Date: Aug. 8, 2002

(54) Tracking system

(76) Inventor: Andrew Arthur Hunter, Bristol (GB)

Correspondence Address: HEWLETT-PACKARD COMPANY, Intellectual Property Administration, P.O. Box 272400, Fort Collins, CO, 80527-2400, US

(21) Appl. No.: 10/025,702

(22) Filed: Dec. 19, 2001

(30) Foreign Application Priority Data
Feb. 3, 2001 (GB) 0102729.1

(51) Int. Cl. H04N 5/225

(52) U.S. Cl. 348/169; 348/143

(57) ABSTRACT

A tracking system comprising a plurality of cameras (10,12,14,16) at each of a plurality of locations within a predetermined area in which a movable subject (20) may be located. The outputs of the cameras (10,12,14,16) are monitored by an attention controller (18) which identifies the presence of the subject (20) in the view of one of the cameras (10,12,14,16) and links the output of that camera to a single remote access point where an image of the subject (20) can be viewed on a screen (22). If the subject (20) moves out of the view of a first camera into the view of a second camera, this is identified by the attention controller (18), which then breaks the link between the remote access point and the first camera and instead links the output of the second camera to the remote access point. Thus, a plurality of moving subjects can be tracked from location to location, said subjects being viewable via separate remote access points.

### FIELD OF THE INVENTION

This invention relates to a tracking system and, in particular, to a system for tracking a moving subject.

It is known to provide, for example, a web camera to capture images which can be viewed remotely via a dedicated web page through the Internet. Thus, in one prior art system, several cameras are placed in, for example, a nursery and parents of children attending the nursery can view the images captured by the cameras via associated dedicated, secure web pages through the Internet.

However, when the subject of interest is moving, they may not always be within the view of the camera which is being accessed, in which case the user may need to access several web pages (using, for example, a web browser) thereby viewing the images captured by several cameras before the subject is located. Further, if the user wishes to follow the subject as it moves, they must guess which cameras to access in order to follow its progress.

We have now devised an arrangement which overcomes the problems outlined above.

### SUMMARY OF THE INVENTION

In accordance with the present invention, there is provided a tracking system for receiving images from a plurality of cameras, each at one of a plurality of locations at which one or more of a plurality of movable subjects or items may be located, each of said cameras being arranged to capture images at said respective location, the system comprising a different remote access point allotted to each of said plurality of movable subjects or items, from which remote access point images of a respective movable subject or item captured by said plurality of cameras can be viewed in real time or near-real time and/or recorded, locator means for determining a first location of a movable subject or item, selecting a first camera at said first location and linking the output of said first camera to the remote access point allotted to said movable subject or item and for determining when said movable subject or item moves from said first location to a second location, selecting a second camera at said second location and linking the output of said second camera to the remote access point allotted to said movable subject or item.

Thus, for example, a single dedicated web page could be used to access images of each of a plurality of moving subjects of interest at any given time, irrespective of their location. The system continues to track the one or more subjects of interest and, as it/they move from location to location, selectively links the output of the appropriate camera(s) to the remote access points allotted to the subject(s) of interest so that a remote access point can be used to view images of each particular subject at any given time, irrespective of their location(s). It is significant that in the present invention, by switching links, a subject can be monitored without any user interaction, which provides substantial advantages over the prior art.

In general, in the present invention, a set of cameras is managed automatically such that each of a plurality of subjects or items of interest can have a unique remote access point (as opposed to the access point being unique to a specific camera as might be the case in the prior art). Multiple subjects or items of interest can be tracked by the system of the present invention, even if they appear in the images being captured by the same camer(s). It will be appreciated that the cameras need not be part of the system itself, but may instead comprise environmental cameras deployed for other purposes.

As the subject or item of interest moves out of the view of a first camera and into the view of a second camera, the view from the second camera replaces the view from the first camera at the same unique remote access point.

Clearly, the images from the plurality of cameras could be subject to some deliberate or unavoidable time delay. Where relative delays are known, a person skilled in the art would appreciate that the apparatus of the present invention could be modified to enable a time-ordered sequence to be linked to the access point even though the actions of the subject may no longer be shown in real-time.

Examples of applications in which the present invention could be used would include watching a single selected schoolchild (via their own unique access point) as he/she moves between classrooms, the school playground, the school bus, etc., watching a single selected sports competitor as he/she moves around a race track, watching a single selected car as it moves around the streets of a town (which would be particularly useful if the car had been stolen), and tracking a single selected person or family group at a holiday destination, in order that an absent family member can share the holiday experience as it occurs, for example.

In one embodiment of the invention, when a specific remote access point is accessed, the system may be arranged to search for the item or subject to which that remote access point is allotted and provide an image of that subject or item, and then track the subject or item as it moves around the predetermined area only while that remote access point is being accessed. Alternatively, however, the system continually tracks each subject or item and updates the camera output available at the respective remote access points, irrespective of whether or not they are actually being accessed.

The system preferably comprises a central database containing details of the various subjects of interest and their allotted unique remote access point, the cameras and their respective locations.

Many different types of tracking means would be suitable for use in the present invention. For example, visually recognisable features could be tracked (such as a number plate on a vehicle, a distinguishing feature of a weather front, or a distinctive clothing or badge worn or carried by the item or subject of interest). Alternatively, several types of electronic tagging system are known. Any suitable type of tracking means may be used in the present invention and this patent specification is not intended to be limiting in this respect.

The apparatus of the present invention may provide for some interaction between the user (i.e. the person accessing an allotted remote access point) and the camera. For example, if the subject or item of interest is at a location which is in the view of two or more cameras, the system may be arranged to provide two or more views at the remote access point for selection by the user if required. In another embodiment, the user may have the option to view a close-up from one of the cameras or a longer view including more of the subject's surroundings. Other modifications of the original source images, such as cropping, sharpening or superimposing an indicator (such as an arrow) pointing to the subject within a view, may also be possible.

The remote access point for each subject or item is preferably only accessible to respective authorised users by means of, for example, the entry of a code number or password. The apparatus may provide means for selectively recording the views fed to each remote access point. Further, the apparatus may include alarm means to alert the authorised user that the subject or item of interest has moved outside of a predetermined area.

The apparatus may be adapted so that the same remote access point can be used to track two or more (possibly related) subjects or items of interest.

There are two preferred ways in which the present invention may be implemented. In the first method, the apparatus comprises an attention controller which may be inserted between a plurality of cameras and one or more remote access points. The attention controller is configured to recognise specific items of interest and to associate each with its own remote access point (or URL). The controller tracks the items as they move between the cameras views and maps the resulting camera outputs to the appropriate remote access points (or web pages via the associated URL). The attention controller may be configured to continually track the subject(s) of interest and output the appropriate views, or it may be arranged to predict the next camera view to contain the subject as it moves, using knowledge of camera positions and/or subject motions, and map the predicted camera output to the remote access point. The attention controller may be implemented using several known methods of identifying items and tracking their motion.

In the second possible implementation of the present invention, the apparatus may comprise an attention controller which is configured to monitor multiple camera views available, for example, via the Internet, identifying any items of interest in the views being monitored and map the outputs of the cameras to the respective remote access points associated with the items of interest identified.

It will be understood that all references herein to “cameras” is intended to encompass image capturing devices generally.

### BRIEF DESCRIPTION OF THE DRAWING

An embodiment of the present invention will now be described by way of example only and with reference to the accompanying drawing which is a schematic block diagram illustrating the basic manner of operation and functions of tracking systems according to an exemplary embodiment of the present invention.

### DETAILED DESCRIPTION OF THE INVENTION

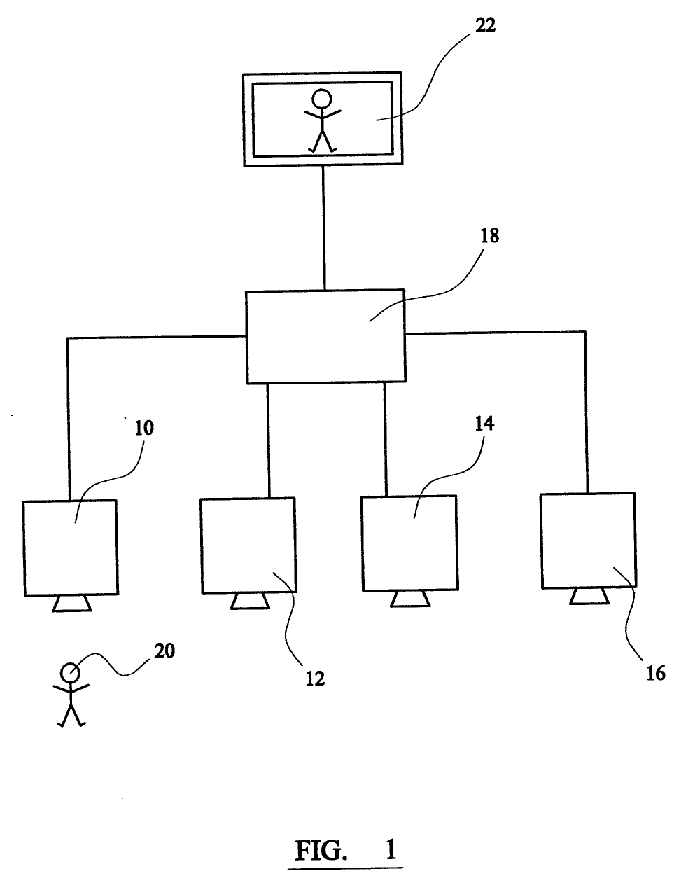

Referring to FIG. 1, an exemplary embodiment of a tracking system according to the present invention comprises first, second, third and fourth cameras 10, 12, 14 and 16 at first, second, third and fourth respective locations. The outputs of said cameras 10, 12, 14, 16 are connected to an attention controller 18.

The attention controller 18 monitors the outputs of said cameras 10,12,14,16 to locate a subject 20 of interest by identifying a visually recognisable feature in said camera outputs.

If, for example, the attention controller 18 determines that the subject 20 appears in the output from the first camera 10, it links the output from the first camera to a remote access point allotted to that subject 20, say a dedicated web page, accessible through the Internet, so that the output from the first camera 10 can be viewed on a screen 22.

If the subject 20 then moves out of the view of the first camera 10 and into the view of the second camera 12, this is identified by the attention controller 18 which then breaks the link between the first camera 10 and the remote access point and instead links the output of the second camera 12 to the same remote access point. This process is repeated if the subject 20 moves out of the view of the second camera 12 into the view of the third camera 14, and so on, so that a dedicated remote access point can be used to track the movements of the subject 20 between a plurality of locations. It will be appreciated that the system can be arranged to track the movements of a plurality of subjects in this way (simultaneously) and provide a dedicated remote access point for viewing images of each of the subjects as required.

A specific embodiment of the present invention has been described above by way of example only, and it will be apparent to a person skilled in the art that modifications and variations can be made to the described embodiment without departing from the scope of the invention as defined by the appended claims.

1. A tracking system for receiving images from a plurality of cameras, each at one of a plurality of locations at which one or more of a plurality of movable subjects or items may be located, each of said cameras being arranged to capture images at said respective location, the system comprising a plurality of remote access points, each of which is allotted to a different one or subset of said plurality of movable subjects or items, from each of which remote access points images of the movable subject or item to which it is allotted captured by said plurality of cameras can be viewed in real time or near-real time and/or recorded, and locating apparatus for determining a first location of a movable subject or item, selecting a first camera at said first location and linking the output of said first camera to the remote access point allotted to the said movable subject or item, and for determining when the said movable subject or item moves from said first location to a second location, selecting a second camera at said second location and linking the output of said second camera to the remote access point allotted to the said movable subject or item.

2. A tracking system according to claim 1, wherein when a remote access point is accessed, the locating apparatus is arranged to search the images being captured by said cameras to determine the locations of the subjects or items to which said remote access point is allotted.

3. A tracking system according to claim 1, wherein said locating apparatus is arranged to track the movable subjects or items and selectively link the outputs of the appropriate cameras to the respective remote access points allotted thereto, irrespective of whether or not said remote access points are being accessed.

4. A tracking system according to claim 1, comprising a central database containing details of a plurality of subjects or items of interest together with their respective allotted remote access points, and/or details of said cameras together with their respective locations.

5. A tracking system according to claim 1, wherein said locating apparatus is arranged to determine the location of a subject or item by identifying a visually recognisable feature thereof in the images captured by said cameras.

6. A tracking system according to claim 1, wherein said subject or item of interest is provided with an electronic tag, and said locating apparatus is arranged to determine the location of the subject or item of interest by determining the location of the electronic tag.

7. A tracking system according to claim 1, wherein said locating apparatus is arranged to determine the location of said subject or item of interest and, in the event that there are two or more cameras associated with said location, link the outputs of said two or more cameras to said remote access point.

8. A tracking system according to claim 7, comprising selection apparatus for selecting to view one of said two or more outputs linked to said remote access point.

9. A tracking system according to claim 1, comprising apparatus for altering the field of view of the camera whose output is linked to said remote access point and/or comprising apparatus to provide a link to a selected area of modified level of detail of the view.

10. A tracking system according to claim 1, wherein said remote access point is accessible only to one or more authorised users.

11. A tracking system according to claim 1, comprising recording apparatus for selectively recording the camera output or outputs linked to a remote access point.

12. A tracking system according to claim 1, comprising alarm apparatus arranged to be actuated in the event that a subject or item of interest moves to a location outside a predetermined area.

13. A tracking system according to claim 1, wherein a single remote access point can be used to track two or more subjects or items of interest.

14. A tracking system according to claim 1, comprising an attention controller arranged to monitor the outputs of said plurality of cameras, determine the presence in said outputs of one or more subjects or items of interest and link the camera output or outputs in which said subject(s) or item(s) are present to the respective remote access point(s) allotted to said subject(s) or item(s).

15. A tracking system according to claim 1, wherein in the event that two or more of said plurality of movable subjects or items to which two or more respective access points are allotted are determined by said locating apparatus to be at the same location, the output of the camera at that location can be linked to both or all of said two or more respective access points.
